(19) United States
(12) Patent Application Publication
(10) Pub. No.: US 2002/0100847 A1
(43) Pub. Date: Aug. 1, 2002

(54) Mounting system for supporting computing devices

(76) Inventor: Robert Lopez, San Jose, CA (US)

Correspondence Address: James A. LaBarre, BURNS, DOANE, SWECKER & MATHIS, L.L.P., P.O. Box 1404, Alexandria, VA, 22313-1404, US

(21) Appl. No.: 09/772,855

(22) Filed: Jan. 31, 2001

(51) Int. Cl. F16M 11/00; E04G 3/08

(52) U.S. Cl. 248/201; 248/250

(57) ABSTRACT

A mounting system for supporting computing devices in a rack of the type having at least two vertical posts. A pair of generally L-spaced brackets are adapted to be respectively mounted to the two posts, each of the brackets having a first elongated strip that is vertically disposed when the bracket is mounted on one of the two posts, and a second elongated strip at one edge of the first elongated strip that is horizontally disposed when the bracket is mounted on a post to form a support surface for the computing device. The second elongated strip has a curvature adjacent the first elongated strip that forms a ridge along the length of the strip upon which a computing device rests when supported by the bracket.

### BACKGROUND OF THE INVENTION

1. Field of the Invention

The present invention relates generally to a mounting system for supporting computing devices. More specifically, the present invention relates to a mounting system for computing devices in a rack having at least two vertical posts used to support multiple computing devices.

2. Discussion of Related Art

With the growing speed of technology, specifically with processing devices, the ability to have the various components of the processing device be minimized in size has increased. As a result, it has become quite common to locate large numbers of servers and other computing devices, which form the infra-structure of Internet web sites, and other communication network resources, in a large, warehouse-like facility known as a data center, or “server farm”. The fees for leasing space in such facilities are charged on the basis of the amount of floor space that is occupied, and so it is desirable to be able to stack as many devices on one another as possible. To this end, there is a need for the reduction of the storage/supporting systems which hold the computing devices.

FIG. 1a illustrates a top view of a support system 100 commonly known as a “rack”. The rack comprises two vertical support beams 110. The two vertical support beams 110 are connected to a supporting platform 130 by a plurality of flange portions 120. As shown in FIG. 1a the support platform 130 is a wide rectangular member which is at least as large as the computing device which it supports. FIG. 1b is a side view of the rack 100 showing the flange portion 120 connected to the two vertical support beams 110 by a plurality of pin members 140.

The rack support system 100 shown in FIGS. 1a and 1b has certain disadvantages. Principally, the device support structure takes up a significant amount of vertical space, requiring greater expenses for users of the system. Typically, shelving systems and rack managed storage systems have a measuring quantity called a “unit” (U). Each unit represents 1.75 inches in height. The height X of the flange portion 130 along the vertical posts is typically in the range of 3 Units (3U). Due to the configuration of the support structure, the platforms 130 which are mounted between the two support beams 110 must be vertically separated by at least 3U. Thus, generally the racks which are 42U in height would by able to hold 14 servers or other computing devices. However, with the advances in technology, many servers now have a profile which is less than 3U in height, enabling more of them to be stacked in a single rack. Hence, the minimum vertical spacing that is required by a system such as that shown in FIGS. 1a and 1b results in wasted space.

### SUMMARY OF THE INVENTION

The present invention provides a mounting system which is compact and is able to support a plurality of computing devices. Furthermore, the present invention provides a mounting system wherein the user is able to easily access the computing devices being supported by the mounting system. Because the mounting system has a novel compact configuration, users are able to effectively support more computing devices between the support beams of the rack. Consequently, users will be able to more efficiently apportion the costs required for storing server units and other computing devices.

The present invention provides the above mentioned advantages, amongst other advantages, by having a mounting system for supporting computing devices in a rack of the type having two vertical posts, including four mounting bases, each base including an elongated strip having a flange at one end thereof for attachment to a post, each strip having a generally planar section that is vertically is mounted on one of the two posts, and a second elongated strip at one edge of the first elongated strip that is horizontally disposed when the bracket is mounted on a post to form a support surface for the computing device. The second elongated strip has a curvature adjacent the first elongated strip that forms a ridge along the length of the strip upon which a computing device rests when supported by the bracket. Due to this configuration, each pair of brackets is able to fully support the weight of a computing device such as a server, while occupying no more than 1U in height, to thereby provide a compact storage arrangement.

### BRIEF DESCRIPTION OF THE DRAWINGS

The invention will now be described in greater detail with reference to the preferred embodiments illustrated in the accompanying drawings, in which like elements bear like reference numerals, and wherein:

FIGS. 1a and 1b illustrate a top view and a side view, respectively, of a prior art mounting apparatus used for storing computing devices;

FIG. 2 illustrates a perspective view of an exemplary embodiment of the mounting system of the present invention;

FIG. 3 illustrates a side view of a computing device loaded on the brackets of the mounting system;

FIG. 4 illustrates a top view of an exemplary embodiment of the present invention including clamping members;

FIG. 5a illustrates a perspective view of an exemplary embodiment of the mounting base of the mounting system;

FIG. 5b illustrates a side view of the mounting base and the bracket in a closed position; and

FIG. 5c illustrates a top view of the mounting bases connected to the posts.

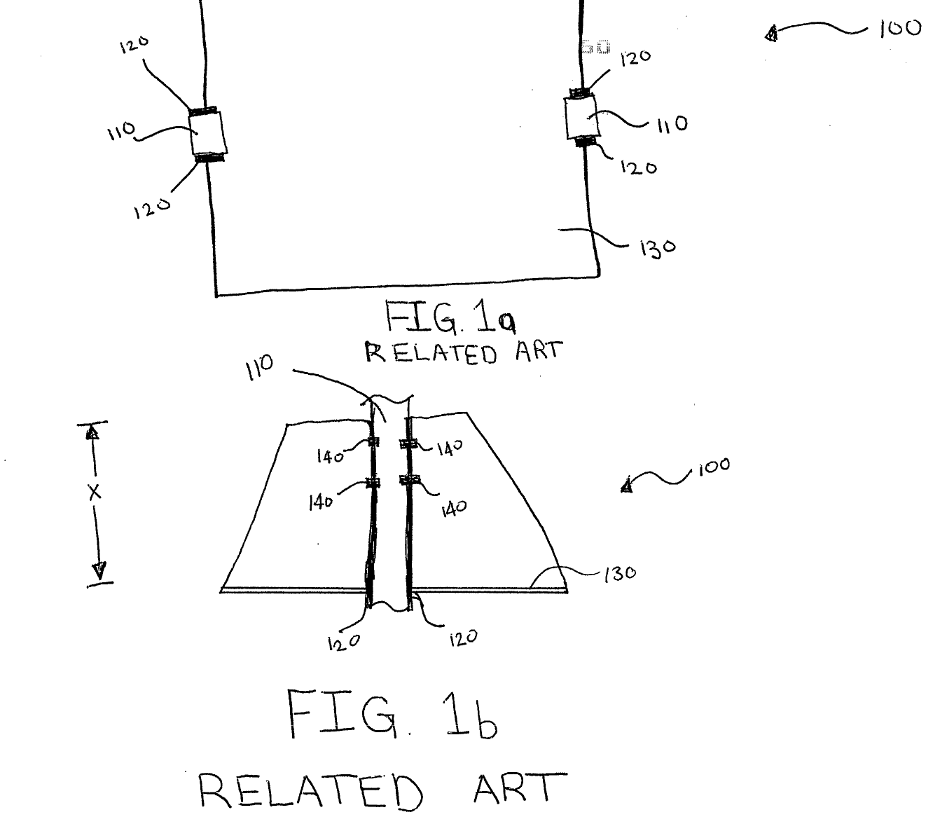

### DETAILED DESCRIPTION OF THE INVENTION

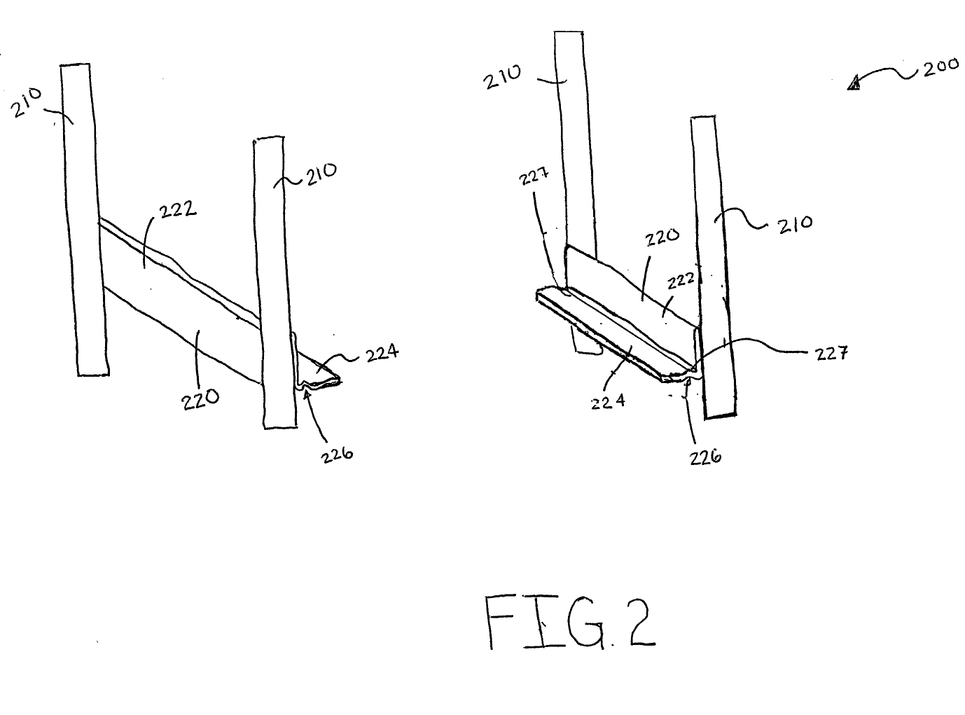

FIG. 2 illustrates an exemplary embodiment of a mounting system 200 for supporting computing devices in a rack of the type having at least two vertical posts 210. It should be appreciated that FIG. 2 shows one exemplary embodiment wherein there are four vertical posts 210, which are respectively located at the four corners of a computing device (not shown in FIG. 2). However, the present invention may be used with a mounting system 200 having fewer posts, as described hereinafter. Preferably the posts 210 are made from stainless steel or the like, as known to one skilled in the art. One of the main purposes of the posts is to provide strong support and accordingly they are configured so as to endure high levels of stress and strain, and possibly torque.

The mounting system 200 further includes a pair of generally L-shaped brackets 220 that are each adapted to be respectively mounted to two of the posts 210. Preferably the brackets 220 are made from stainless steel or the like, as known to one skilled in the art. Each of the brackets 220 includes a first elongated strip 222 that is vertically disposed when the bracket 220 is mounted between two posts 210, and a second elongated strip 224 at a lower edge of the first elongated strip 222 that is horizontally disposed when the bracket 220 is mounted on the posts 210. The horizontal strips of two opposed brackets form a support surface for the computing device (not shown). The second elongated strip 224 has a curvature 226 adjacent the first elongated strip 222 that forms a ridge 227 along the length of the strip. A computing device rests on this ridge when supported by the bracket 220.

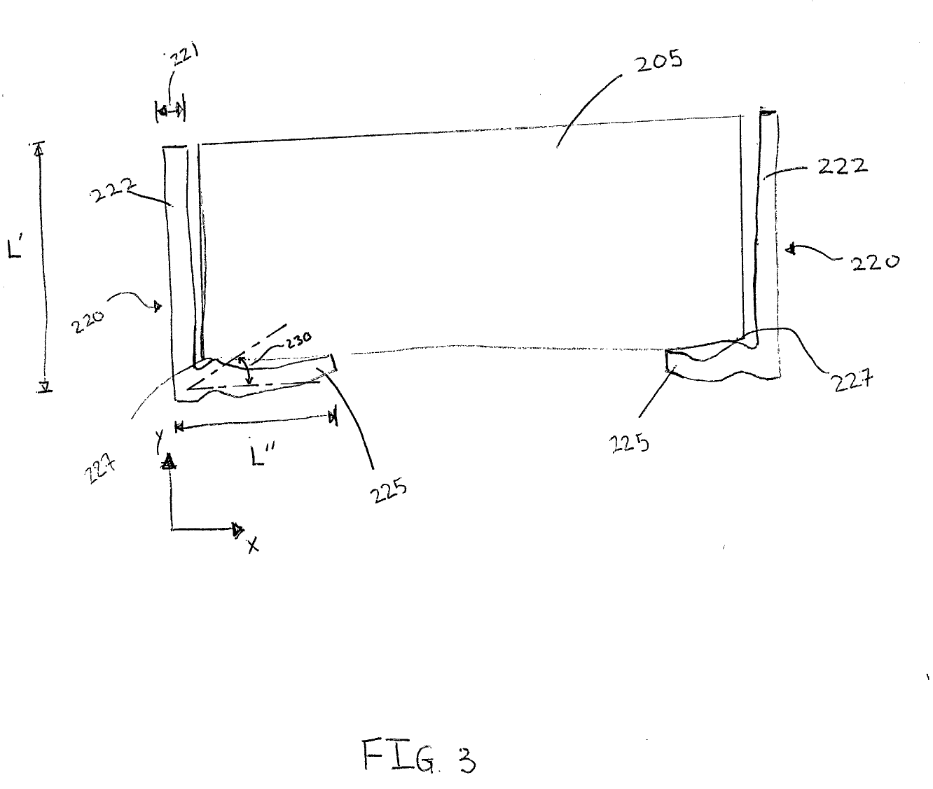

FIG. 3 illustrates a side view of an exemplary embodiment of the brackets 220 supporting a computing device 205. In an exemplary embodiment the first strip 222 and the second strip 224 each have a thickness 221 in the range of approximately 0.125 inch to 0.03125 inch, and preferably about 0.0625 inch. The height L′ of the vertically oriented strip 227 is in the range of 1.75 to 2.25 inches, and. preferably about 2 inches. The width L″ of the horizontally oriented strip 224 is in the range of 2 inches to 2.75 inches, and preferably about 2.5 inches.

In an exemplary embodiment as shown in FIG. 3, near the position where the first strip 222 is joined with the second strip 224, the ridge portion 227 is formed on the second strip 224. The ridge 227 forms an angle 230 of anywhere from 10 degrees to 30 degrees with respect to the X axis, i.e. normal to the plane of the strip 222, at the point where it joins the first strip 222, but preferably the angle is anywhere from 15 degrees to 25 degrees. The ridge 227 is formed by a cold-fold procedure. This configuration of the ridge 227 forms a spring-like structure such that, when the computing device 205 is placed on the brackets 220, as shown in FIG. 3, causes the end portion 225 of the second strip 224 to be pushed upwards (in the Y direction) to come in contact with the bottom portion of the computing device 205 to provide a strong support. This unique configuration allows for the bracket 220 to have a smaller configuration than brackets in the related art.

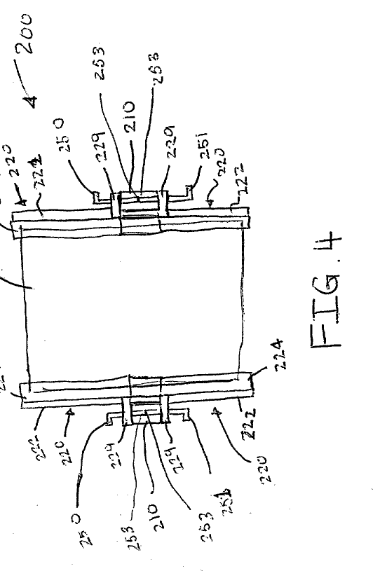

FIG. 4 illustrates a top view of another exemplary embodiment of the mounting system 200, in which only two posts 210 are respectively located on opposite sides of the server 205, at approximately the center thereof. In the exemplary embodiment, the brackets 220 have a flange 229 located on the first strip 222, opposite the side from which the second strip 224 projects. The flange 229 includes an opening (not shown) which can be aligned with openings (not shown) in the post 210. The openings, i.e. of the flange and posts, receive a clamp 250 and 251 which connects and locks the brackets 220 to the posts 210. Furthermore, once the clamps 250 and 251 are disengaged from the opening, a user is able to move the brackets to another position along the posts 210 to change the location of the bracket and supported computing device 205. In the exemplary embodiment shown in FIG. 4, each bracket 220 receives two clamps 250 and 251 wherein the end portions 253 of the clamps 250 and 251 abut each other. The abutment of the two clamps 250 and 251 allows for better support of the computing device and resists torquing of the brackets 220. Furthermore, by providing two clamps on opposite sides of the post the user is more easily able to engage and disengage the clamps to and from the mounting system 200.

However, it should be appreciated that one may use a single clamp to secure each bracket to the respective post. The clamp is configured so that when the clamp is inserted into the openings the user is able to rotate the clamp to place the clamp in a locked position, so that the clamp is not able to easily become disengaged from the bracket and posts.

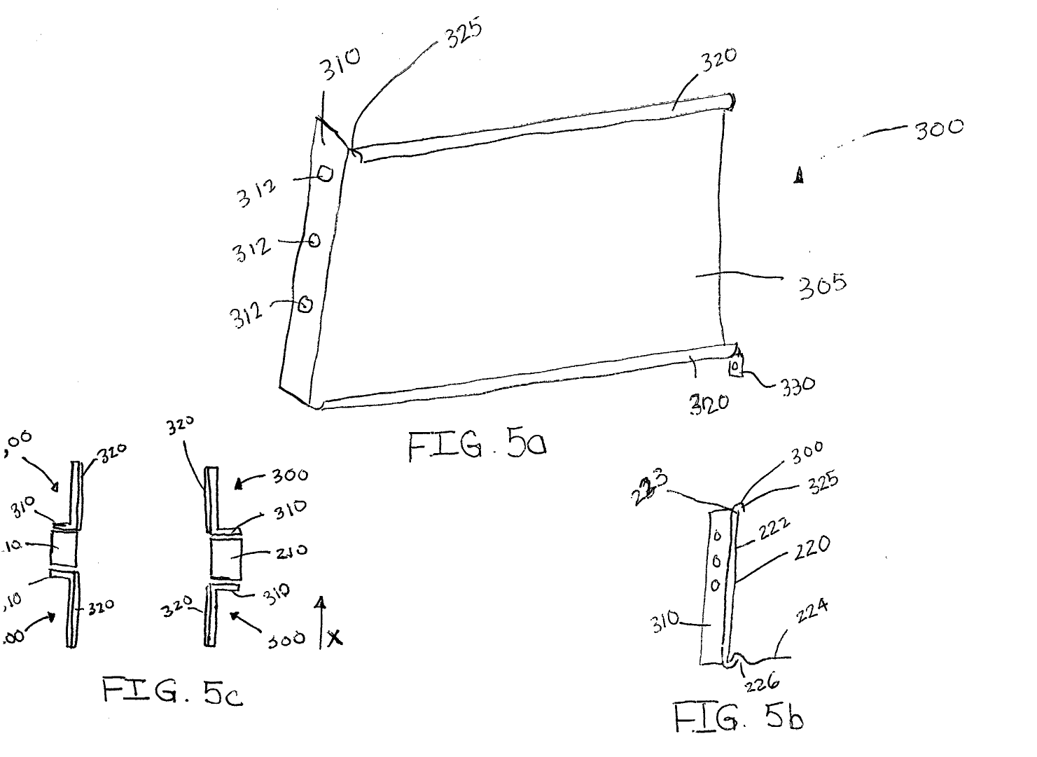

FIG. 5a illustrates a mounting base 300 which is designed to be used in a two-post support arrangement. The mounting base 300 has an elongated strip 305 which includes a flange 310 at one end of the elongated strip 305. The flange 310 has a plurality of openings 312 which are able to be aligned with openings located on the posts 210 and have a locking member (not shown), e.g. bolt, pin, clamp member or the like, connecting the mounting base 300 with the posts 210 through the openings of the respective members. The mounting base 300 further includes a curved section 320 at the top and bottom of the strip 305 to provide a generally C-shaped profile. The curved sections 320 form groove portions 325.

Many types of computing devices are sold with an integrated slide assembly on each of its two sides. The grooves 325 in each mounting base 300 are designed to accommodate these slide assemblies, so that the computing device is able to slide out from between the two posts 210. To prevent inadvertent sliding while a device is mounted, a locking member 330 is included on the mounting base 300 which is able to receive a lock or other type of material which would secure the computing machine to the mounting base 300, and substantially restrict the sliding of the computing device. Thus, in areas where there are earthquakes, computing devices which are stacked between posts with such slide assemblies are more susceptible to sliding and falling off the mounting racks. The present invention thus substantially reduces the likelihood of the computing device falling off the mounting racks by being connected to the stationary mounting base 300.

If a computing device does not have a slide assembly that can be used to connect it to the mounting bases, the brackets 220 can be used to provide a support surface for the devices. As shown in FIG. 5b, the mounting base 300 is able to receive the bracket 220 by sliding the first elongated strip 222 of the bracket 220 between the groove portions 325. Furthermore, the straight upper edge 223 of the first strip 222 is received by a groove portion 325 located at the top of the mounting base 300, while the other end of the first strip 222, where the curved portion 226 of the bracket 220 is located, is received by the groove portion 325 located at the bottom of the mounting base 300.

FIG. 5c illustrates a top view of an exemplary embodiment wherein the four mounting bases 300 are connected to the posts 210 by the flange 310 located on each of the mounting bases 300. Thus, a user is able to mount the computing device on the rack system by inserting the integrated slide assembly of the computing device in the X direction so that it is received by the mounting bases 300 or by inserting the brackets 220 and placing the computing device upon the brackets as previously discussed.

While the invention has been described in detail with reference to preferred embodiments thereof, it will be apparent to one skilled in the art that various changes can be made, and equivalents employed, without departing from the scope of the invention.

What is claimed is:

1. A mounting system for supporting computing devices in a rack of the type having at least two vertical posts, comprising a pair of generally L-spaced brackets that are adapted to be respectively mounted to the two posts, each of the brackets having a first elongated strip that is vertically disposed when the bracket is mounted on one of the two posts, and a second elongated strip at one edge of the first elongated strip that is horizontally disposed when the bracket is mounted on a post to form a support surface for the computing device, the second elongated strip having a curvature adjacent the first elongated strip that forms a ridge along the length of the strip upon which a computing device rests when supported by the bracket.

2. The mounting system of claim 1, wherein said ridge portion has an angle in the range of about 10 degrees to about 30 degrees with respect to the normal to said first strip.

3. The mounting system of claim 1, wherein the second elongate strip has an edge remote from said first strip that, when the computing device is placed on the brackets, moves in an upward direction towards the computing device until said edge is in contact with and supports the computing device.

4. The mounting system of claim 1, wherein the brackets are connected to the posts by a flange portion.

5. The mounting system of claim 1, wherein each bracket further includes a clamping device disposed on a side of the first elongated strip opposite the second elongated strip for attaching the bracket to a vertical post.

6. The mounting system of claim 1, wherein the brackets have a thickness in the range of approximately 0.125 inches to 0.03125 inches.

7. The mounting system of claim 1, wherein the first strip has a height in the range of 1.5 inches to 2.25 inches.

8. The mounting system of claim 1, wherein the ridge is formed by a cold-fold procedure.
